(19) United States
(12) Patent Application Publication
(10) Pub. No.: US 2015/0042617 A1
(43) Pub. Date: Feb. 12, 2015

(54) LIGHT-ENERGY SENSING APPARATUS AND A METHOD OF OPERATING THE SAME

(71) Applicant: HengHao Technology Co. LTD, Taoyuan County (TW)

(72) Inventor: MING-SHAN KUO, Taoyuan County (TW)

(73) Assignee: HengHao Technology Co. LTD, Taoyuan County (TW)

(21) Appl. No.: 13/966,149

(22) Filed: Aug. 13, 2013

(30) Foreign Application Priority Data
Aug. 8, 2013 (TW) 102128477

(51) Int. Cl. G06F 3/03

(52) U.S. Cl. CPC G06F 3/0325
USPC 345/175

(57) ABSTRACT

A light-energy sensing apparatus includes a photovoltaic element that converts light emitted from a touch screen into electrical energy as power for a processor. Data is transferred, via an interface, between the processor and an electronic device. A signal transceiver is coupled to receive and amplify signals outputted from the processor, the amplified signals being then transmitted to the touch screen; or, alternatively, the signal transceiver is coupled to receive signals from the touch screen, the received signals being transmitted to the electronic device via the interface.

### CROSS-REFERENCE TO RELATED APPLICATIONS

The entire contents of Taiwan Patent Application No. 102128477, filed on Aug. 8, 2013, from which this application claims priority, are incorporated herein by reference.

### BACKGROUND OF THE INVENTION

1. Field of the Invention

The disclosure generally relates to a photovoltaic element, and more particularly to a light-energy sensing apparatus adapted to communicate with an electronic device via a touch screen.

2. Description of Related Art

Touch screens have been widely adapted to a variety of electronic devices, particularly mobile devices such as tablet personal computers and mobile phones. The operation of the touch screen is nevertheless restricted to the touch screen itself, and is difficult to be communicated to other electronic devices such as digital cameras. Accordingly, functions (particularly communication functions) of the touch screen are thus limited.

On the other hand, radio-frequency identification (RFID) is a common technique used to identify objects by using radio-frequency electromagnetic wave to transfer data. The electromagnetic wave, however, may be harmful to the human body. Moreover, the amount of data that RFID can transfer is quite limited, and the transfer direction of the data is usually fixed to one way only such that bi-directional communication with other systems becomes infeasible.

A need has arisen to propose a novel sensing apparatus by combining common touch display technology and object identification techniques in order to achieve identification and communication at the same time.

### SUMMARY OF THE INVENTION

In view of the foregoing, it is an object of the embodiment of the present invention, to provide a light-energy sensing apparatus, which is powered by electrical energy converted from light emitted from a touch screen and is capable of identifying an electronic device that may bi-directionally communicate with a touch screen.

According to one embodiment, a light-energy sensing apparatus includes a photovoltaic element, a processor, an interface and a signal transceiver. The photovoltaic element is configured to convert light energy of light emitted from a touch screen into electrical energy, and the processor is powered by the electrical energy converted by the photovoltaic element. Data is transferred between the processor and an electronic device via the interface. The signal transceiver is configured to receive and amplify signals outputted from the processor, the amplified signals being then transmitted to the touch screen; or, alternatively, the signal transceiver is configured to receive signals from the touch screen, the received signals being then transmitted to the electronic device via the interface.

### BRIEF DESCRIPTION OF THE DRAWINGS

FIG. 1 shows a schematic diagram illustrating applying a light-energy sensing apparatus according to one embodiment of the present invention;

FIG. 2 shows a schematic diagram illustrating a touch screen; and

FIG. 3 shows a system block diagram illustrating the light-energy sensing apparatus according to one embodiment of the present invention.

### DETAILED DESCRIPTION OF THE INVENTION

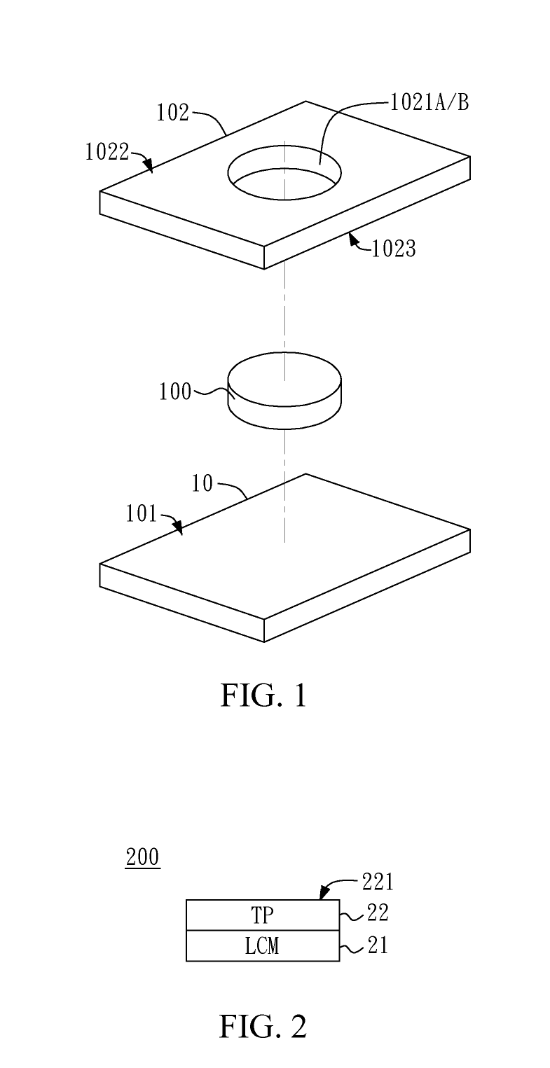

FIG. 1 shows a schematic diagram illustrating an application of a light-energy sensing apparatus 100 according to one embodiment of the present invention. The light-energy sensing apparatus 100 may be fastened to a surface 101 of an electronic device (e.g., a digital camera) 10. A protective layer 102 may be optionally used to cover the light-energy sensing apparatus 100 and the surface 101 of the electronic device 10. The protective layer 102 may be detachably or fixedly coupled to the electronic device 10. Moreover, a transparent layer 1021A having an area corresponding to the light-energy sensing apparatus 100 may be disposed in the protective layer 102 to pass light; or, alternatively, a light guide 1021B having an area corresponding to the light-energy sensing apparatus 100 may be disposed in the protective layer 102 to guide and transfer light from a first surface (e.g., a top surface) 1022 of the protective layer 102 to a second surface (e.g., a bottom surface) 1023 of the protective layer 102. Areas in the protective layer 102 not corresponding to the light-energy sensing apparatus 100 may be made transparent or opaque, and may possess decoration pattern.

The light-energy sensing apparatus 100 of the embodiment may interact with a touch screen. FIG. 2 shows a schematic diagram illustrating a touch screen 200, which includes a display module (e.g., a liquid crystal module (LCM)) 21 and a touch panel (TP) 22. Specifically, the touch panel 22 is disposed above the display module 21, and a top surface of the touch panel 22 acts as a touch surface 221. Light generated by the display module 21 may pass through the touch panel 22, and may be emitted from the touch surface 221.

According to the light-energy sensing apparatus 100 shown in FIG. 1, when the light-energy sensing apparatus 100, directly or indirectly via the transparent layer 1021A/light guide 1021B, approaches or touches the touch surface 221 of the touch screen 200, location of the light-energy sensing apparatus 100 may be detected by the touch screen 200. Moreover, the light-energy sensing apparatus 100 may receive light emitted from the touch surface 221, and the emitted light may then be converted into electrical energy as power required by circuits disposed in the light-energy sensing apparatus 100. Further, the light-energy sensing apparatus 100 may actively transmit signal or data to the touch screen 200; or, alternatively, the light-energy sensing apparatus 100 may receive signals or data transmitted from the touch screen 200 (e.g., an electrode of the touch panel 22).

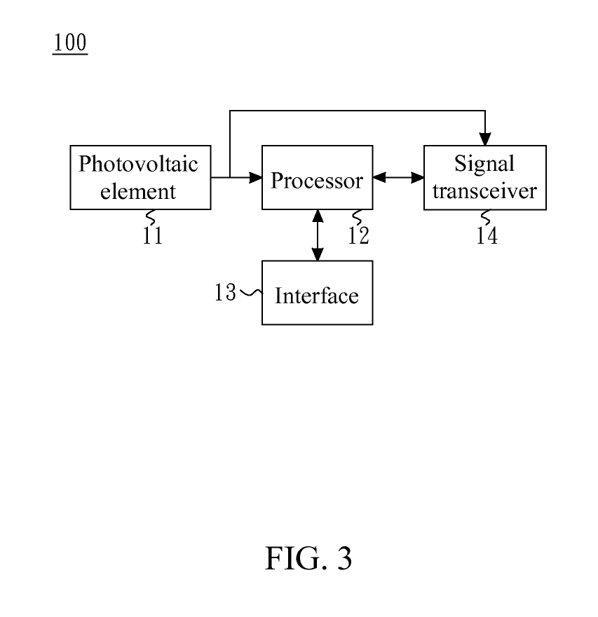

FIG. 3 shows a system block diagram illustrating the light-energy sensing apparatus 100 according to one embodiment of the present invention. In the embodiment, the light-energy sensing apparatus 100 may include a photovoltaic element 11 that converts light energy of light emitted from the touch surface 221 into electrical energy (e.g., electrical current). The photovoltaic element 11 may be a silicon-based solar cell, having an active layer made from a silicon wafer or thin film, where the silicon wafer may be monocrystalline silicon, multicrystalline silicon, or ribbon silicon, and the thin film may be cadmium telluride (CdTe), copper indium gallium selenide (CIGS), or amorphous silicon (A-Si). Alternatively, the photovoltaic element 11 may be a concentrated photovoltaic cell, also named chemical compound-based solar cell, having an active layer made from group III-V compound such as gallium. arsenic (GaAs), indium gallium arsenic (InₓGa₁₋ₓAs), aluminum phosphorus (AlP), or gallium phosphorus (GaP).

The light-energy sensing apparatus 100 of the embodiment may include a processor (e.g., a microprocessor) 12, which is powered by electrical energy converted by the photovoltaic element 11. The light-energy sensing apparatus 100 may include an interface 13, via which data may be transferred between the processor 12 and the electronic device 10. The light-energy sensing apparatus 100 may further include a signal transceiver 14, which is also powered by electrical energy converted by the photovoltaic element 11. The signal transceiver 14 may receive and amplify signals or data outputted from the processor 12, the amplified signals being then transmitted to the touch screen 200; or, alternatively, the signal transceiver 14 may receive signals or data from the touch screen 200, the received signals being then transmitted to the electronic device 10 via the interface 13. Accordingly, the touch panel 22 of the touch screen 2000 may really identify the electronic device 10 (that is, recognize identify in addition to shape). Afterwards, bi-directional communication between the electronic device 10 and the touch screen 200 may be commenced.

Although specific embodiments have been illustrated and described, it will be appreciated by those skilled in the art that various modifications may be made without departing from the scope of the present invention, which is intended to be limited solely by the appended claims.

What is claimed is:

1. A light-energy sensing apparatus, comprising:
a photovoltaic element configured to convert light energy of light emitted from a touch screen into electrical energy;
a processor powered by the electrical energy converted by the photovoltaic element;
an interface, via which data is transferred between the processor and an electronic device; and
a signal transceiver configured to receive and amplify signals outputted from the processor, the amplified signals being then transmitted to the touch screen; or, alternatively, configured to receive signals from the touch screen, the received signals being then transmitted to the electronic device via the interface.

2. The apparatus of claim 1, wherein the photovoltaic element comprises a silicon-based solar cell.

3. The apparatus of claim 1, wherein the photovoltaic element comprises a concentrated photovoltaic cell.

4. The apparatus of claim 1, is fastened to a surface of the electronic device.

5. The apparatus of claim 1, further comprising a protective layer covering the photovoltaic element, the processor, the interface, the signal transceiver and a surface of the electronic device.

6. The apparatus of claim 5, further comprising a transparent layer disposed in the protective layer.

7. The apparatus of claim 5, further comprising a light guide disposed in the protective layer.

8. A method of operating a light-energy sensing apparatus, comprising:
converting light energy of light emitted from a touch screen. into electrical energy;
powering a processor by the converted electrical energy;
transferring data between the processor and an electronic device; and
receiving and amplifying signals outputted from the processor, the amplified signals being then transmitted to the touch screen; or, alternatively, receiving signals from the touch screen, the received signals being then transmitted to the electronic device.

9. The method of claim 8, wherein the light energy is converted by a silicon-based solar cell.

10. The method of claim 8, wherein the light energy is converted by a concentrated photovoltaic cell.

11. The method of claim 8, further comprising a step of fastening the light-energy sensing apparatus to a surface of the electronic device.

12. The method of claim 8, further comprising a step of using a protective layer to cover the light-energy sensing apparatus and a surface of the electronic device.
